(19) United States
(12) Patent Application Publication
(10) Pub. No.: US 2015/0242100 A1
(43) Pub. Date: Aug. 27, 2015

(54) DETECTING INTENTIONAL ROTATION OF A MOBILE DEVICE

(71) Applicant: SONY CORPORATION, Minato-ku, Tokyo (JP)

(72) Inventor: Martin Sohlstrom, Lund (SE)

(73) Assignee: SONY CORPORATION, Tokyo (JP)

(21) Appl. No.: 14/373,450

(22) PCT Filed: Oct. 16, 2013
(86) PCT No.: PCT/IB13/02301

§ 371 Date: Jul. 21, 2014

(51) Int. Cl. G06F 3/0484; G06F 3/0346; G06T 3/60

(52) U.S. Cl. CPC G06F 3/04845; G06T 3/60; G06F 3/0346; G06T 2200/24

(57) ABSTRACT

A method for detecting intentional rotation of a mobile device includes identifying a starting angular position of the mobile device. The mobile device includes a user interface in a first orientation and a first configuration. The method includes identifying a rotation of the mobile device. The method also includes identifying an ending angular position of the mobile device after the rotation, and determining a speed of rotation of the mobile device. The method further includes identifying a rotation angle threshold and a rotation speed threshold. The method includes determining whether the rotation exceeds the rotation angle threshold and the rotation speed threshold, and identifying the rotation as an intentional rotation in response to a determination that the rotation exceeds the rotation angle threshold and the rotation speed threshold.

### BACKGROUND

Mobile devices have the capability to automatically rotate a user interface (UI) between portrait and landscape orientation (or vice versa) when the user rotates the mobile device. This auto-rotation feature is commonly implemented by using an accelerometer that detects when a rotation angle threshold is exceeded (e.g. 45 degrees). A common problem is accidental auto-rotation, for example when the user is lying in bed and unintentionally tilts the mobile device beyond the rotation angle threshold.

### SUMMARY

In one implementation, a computer-implemented method for detecting intentional rotation of a mobile device includes identifying a starting angular position of the mobile device. The mobile device includes a user interface in a first orientation and a first configuration. The method includes identifying a rotation of the mobile device. The method also includes identifying an ending angular position of the mobile device after the rotation, and determining a speed of rotation of the mobile device. The method further includes identifying a rotation angle threshold and a rotation speed threshold. The method includes determining whether the rotation exceeds the rotation angle threshold and the rotation speed threshold, and identifying the rotation as an intentional rotation in response to a determination that the rotation exceeds the rotation angle threshold and the rotation speed threshold.

In addition, the method may further include switching the user interface to a second orientation in response to a identifying that the rotation as an intentional rotation.

In addition, the method may further include switching the user interface to a second configuration in response to identifying that the rotation as an intentional rotation.

In addition, the first configuration may include a regular backlighting configuration and the second configuration may include an amplified backlighting configuration.

In addition, the method may further include maintaining the user interface in the first orientation in response to a determination that the rotation does not exceed the rotation speed threshold.

In addition, the method may further include determining whether the rotation is the intentional rotation based on a fluidity of the rotation.

In addition, the method may further include multiple rotation angle thresholds

In addition, the method may further include determining whether the rotation exceeds a second rotation angle threshold in response to a determination that the rotation exceeds the rotation angle threshold and does not exceed the rotation speed threshold, and switching the user interface to the second orientation in response to a determination that the rotation exceeds the second rotation angle threshold.

In addition, the method may further include determining whether the mobile device is moved in a perpendicular plane of motion in a predetermined time span of the time of the rotation, and switching the user interface to the second orientation in response to a determination that the mobile device is moved in a perpendicular plane of motion in a predetermined time span of the time of the rotation.

In addition, the method may further include determining whether a secondary input is received at the mobile device in a predetermined time prior to the rotation, and switching the user interface to the second orientation in response to a determination that the secondary input is received at the mobile device in a predetermined time prior to the rotation.

In addition, when determining the speed of rotation of the mobile device, the method may further include determining the speed of rotation of the mobile device based on the rotation angle and the time of rotation of the mobile device.

In addition, the method may further include determining whether a change in the rotation angle exceeds a predetermined threshold, and identifying the rotation as the intentional rotation in response to a determination that the change in the rotation angle exceeds a predetermined threshold.

In another implementation, a mobile device may include a user interface configurable to be displayed in a first orientation or a second orientation, a memory to store a plurality of instructions, and a a processor configured to execute instructions in the memory to identify a starting angular position of the mobile device, wherein the user interface in the first orientation and a first configuration, identify a rotation of the mobile device, identify an ending angular position of the mobile device after the rotation, determine a speed of rotation of the mobile device, identifying a rotation angle threshold, identify a rotation speed threshold, determine whether the rotation exceeds the rotation angle threshold and the rotation speed threshold, and identify the rotation as an intentional rotation in response to a determination that the rotation exceeds the rotation angle threshold and the rotation speed threshold.

In addition, the processor is to switch the user interface to a second orientation in response to a identifying that the rotation as an intentional rotation.

In addition, the processor is to switch the user interface to a second configuration in response to a identifying that the rotation as an intentional rotation.

In addition, the second configuration includes at least one of an enlarged image, or a backlit interface.

In addition, the processor is to lock the user interface in the first orientation in response to a determination that the rotation does not exceed the rotation speed threshold.

In addition, the processor is to determine whether the rotation exceeds a second rotation angle threshold in response to a determination that the rotation exceeds the rotation angle threshold and does not exceed the rotation speed threshold, and switch the user interface to the second orientation in response to a determination that the rotation exceeds the second rotation angle threshold.

In addition, the processor is to determine whether a secondary input is received at the mobile device in a predetermined time prior to the rotation, and switch the user interface to the second orientation in response to a determination that the secondary input is received at the mobile device in a predetermined time prior to the rotation.

In addition, the processor is further to determine whether a change in the rotation angle exceeds a predetermined threshold, and identify the rotation as the intentional rotation in response to a determination that the change in the rotation angle exceeds a predetermined threshold.

In yet another implementation, a computer-readable medium includes instructions to be executed by a processor in an audio device, for causing the processor to identify a starting angular position of the mobile device, wherein the user interface in a first orientation and a first configuration, identify a rotation of the mobile device, identify an ending angular position of the mobile device after the rotation, determine a speed of rotation of the mobile device, identify a rotation angle threshold and a rotation speed threshold, determine whether the rotation exceeds the rotation angle threshold and the rotation speed threshold, identify the rotation as an intentional rotation in response to a determination that the rotation exceeds the rotation angle threshold and the rotation speed threshold, and switch the user interface to a second orientation in response to a identifying that the rotation as an intentional rotation.

### BRIEF DESCRIPTION OF THE DRAWINGS

The accompanying drawings, which are incorporated in and constitute part of this specification, illustrate one or more embodiments described herein and, together with the description, explain the embodiments. In the drawings:

FIGS. 1A and 1B illustrate, respectively, intentional rotation of a mobile device and unintentional rotation of the mobile device consistent with embodiments described herein;

FIG. 2 illustrates an exemplary device consistent with embodiments described herein;

FIG. 3 is a block diagram of exemplary components of the device of FIG. 2;

FIG. 4 is an exemplary functional block diagram of components implemented in the intentional rotation detection module of FIGS. 1A and 1B;

FIG. 5 is a block diagram illustrating concepts described herein for detecting intentional rotation of a mobile device;

FIGS. 6A and 6B are block diagrams illustrating concepts described herein for, respectively, applying a second configuration to a mobile device or maintaining the mobile device in a first configuration based on the detected rotation; and

FIG. 7 is a flow diagram of an exemplary process for determining whether a detected rotation of a mobile device is an intentional rotation or an unintentional rotation, consistent with implementations described herein.

### DETAILED DESCRIPTION

The following detailed description refers to the accompanying drawings. The same reference numbers in different drawings may identify the same or similar elements. It should be noted that the drawings have not been drawn to scale and that the dimensions of certain features have been exaggerated for the sake of clarity. Also, the following detailed description is exemplary and explanatory only and is not restrictive of the invention, as claimed.

Embodiments described herein relate to devices, methods, and systems for detecting intentional rotation of a mobile device. In implementations described herein, an angular position of a mobile device may be identified. A rotation of the mobile device beyond a rotation angle threshold may be detected. A speed of rotation of the mobile device during the rotation may be determined. A rotation speed threshold for detecting intentional rotation of a mobile device may be accessed. If the speed of rotation is greater than the rotation speed threshold, the configuration of the mobile device may be switched from a first orientation to a second orientation.

Consistent with embodiments described herein, aspects associated with the motion of the mobile device prior to or during rotation may be analyzed to determine whether the rotation is intentional rotation or unintentional rotation. Additionally, different configurations may be implemented on the mobile device based on a particular orientation of the mobile device.

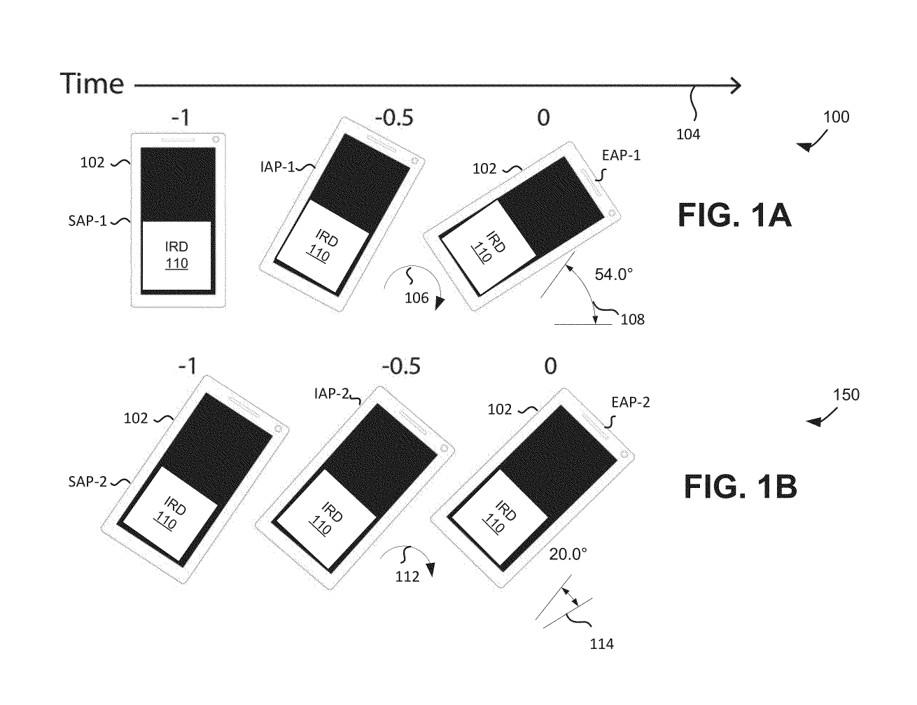

FIGS. 1A and 1B illustrate concepts described herein. More specifically, FIG. 1A shows progression of intentional rotation of a mobile device 102 and FIG. 1B shows progression of unintentional rotation of mobile device 102 through different angular positions over a predetermined time 104.

Mobile device 102 may be a handheld device that includes a capability to change an orientation of a user interface based on a detected angular position of the mobile device 102. Mobile device 102 may be configured to implement a first orientation (e.g., portrait orientation) when mobile device 102 is in an upright angular position (i.e., the length of mobile device 102 is perpendicular to the ground) and a second orientation (e.g., landscape orientation) when mobile device 102 is in a flat angular position (i.e., the length of mobile device 102 is parallel to the ground). Mobile device 102 may include, for example, a gaming console, a personal communications system (PCS) terminal (e.g., a smartphone that may combine a cellular radiotelephone with data processing and data communications capabilities), a tablet computer, or other types of computation or communication devices.

Mobile device 102 may determine whether a rotation of mobile device 102 between the upright angular position and the flat angular position that crosses the rotation angle threshold (e.g., a 45 degree angle) is an intentional rotation 106 of mobile device 102 based on particular aspects of user behavior and/or device motion associated with the rotation. Mobile device 102 may include an intentional rotation detection (IRD) module 110 that may detect rotation of mobile device and distinguish between intentional rotation 106 of mobile device 102, as shown in FIG. 1A, and unintentional rotation 112 of mobile device 102, as shown in FIG. 1B.

IRD module 110 may identify (i.e., receive a predetermined instruction) that intentional rotations 106 tend to have a larger movement in a short amount of time, i.e. higher rotation speed. As shown in FIG. 1A, IRD module 110 may determine that the rotation is an intentional rotation 106 if the speed of rotation is greater than a predetermined rotation speed threshold.

According to an example, described with respect to FIG. 1A, IRD module 110 may determine a rotation angle 108 between a starting angular position (SAP-1) of mobile device 102, at which the device is initially at rest through intermediate angular positions (e.g., IAP-1) to an ending angular position (EAP-1) of the mobile device 102 after the intentional rotation 106. IRD module 110 may also determine a rotation time 104 of the rotation and determine a speed of the rotation based on the rotation angle 108 and rotation time 104.

As shown in FIG. 1B, IRD module 110 may identify that unintentional auto-rotations 112 tend to have a relatively smaller movement in a corresponding amount of time to an intentional rotation 106 (and consequently at a lower rotation speed). IRD module 110 may also determine an unintentional rotation angle 114 between a starting angular position (SAP-2) of mobile device 102, at which the device is initially at rest and an ending angular position (EAP-2) of the mobile device 102 after the unintentional rotation 112. Unintentional rotation 112 may occur when the user is lying on the side with the device in the hand in a set position and accidentally tilts the device (e.g., a few degrees) above the rotation threshold, i.e. a smaller rotation speed.

In implementations described herein, systems and methods may distinguish between intentional rotation 106 and unintentional rotation 112 based on attributes of motion associated with intentional rotation 106 and unintentional rotation 112 of the mobile device. The systems and methods may prevent unintended auto-rotation by detecting how users behave when they intentionally want to rotate the UI. For example, the systems and methods may combine the rotational speed with other variables associated with rotation of mobile device 102 (intentional or unintentional rotation), such as a direction of motion of mobile device 102, a stability of position of mobile device 102, a fluidity of motion of the mobile device 102 during the rotation, touch input provided to the mobile device 102, etc.

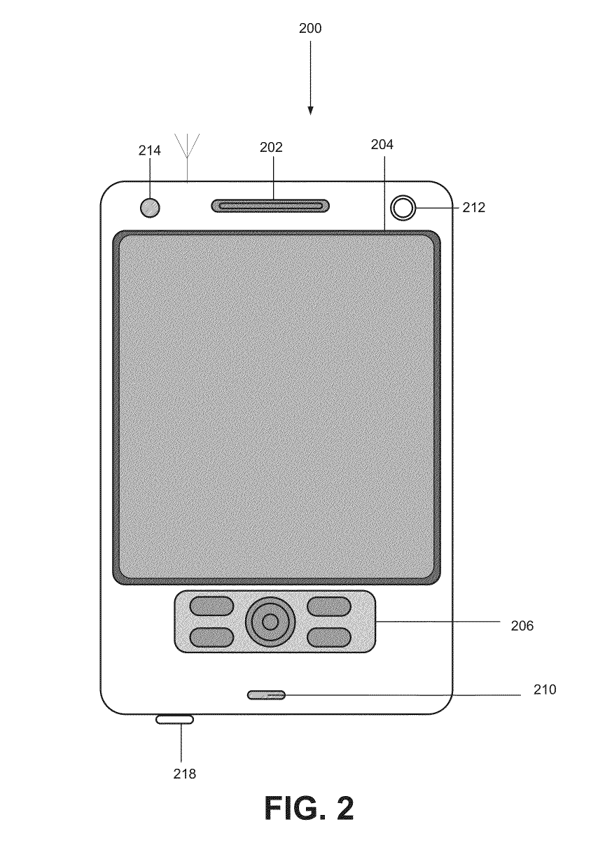

FIG. 2 is a diagram of an exemplary audio device 200 in which the concepts described herein may be implemented. Device 200 may include any of the following devices: a music player device (e.g., a Moving Picture Experts Group (MPEG) MPEG-1 or MPEG-2 audio layer III (mp3) player, compact disc (CD) player, cassette player, etc.), a mobile telephone; a cellular phone; a personal communications system (PCS) terminal that may combine a cellular radiotelephone with data processing, facsimile, and/or data communications capabilities; an electronic notepad and/or a tablet computer; a personal digital assistant (PDA) that can include a telephone; a gaming device or console; or another type of device that may be positioned in different angular positions during operation.

In this implementation, device 200 may take the form of a mobile phone (e.g., a cell phone). As shown in FIG. 2, device 200 may include a speaker 202, a touchscreen display 204, control buttons 206, a microphone 210, sensors 212, a front camera 214, a housing 216, and a headphone jack socket 218.

Speaker 202 may provide audible information to a user of device 200.

Display 204 may provide visual information to the user, such as an image of a caller, video images, or pictures. In addition, display 204 may include a touchscreen for providing input to device 200. Display 204 may provide hardware/software to detect the coordinates of an area that is touched by user 110. For example, display 204 may include a display panel, such as a liquid crystal display (LCD), organic light-emitting diode (OLED) display, and/or another type of display that is capable of providing images to a viewer. Display 204 may include a transparent panel/surface for locating the position of a finger or an object (e.g., stylus) when the finger/object is touching or is close to display 204.

Control buttons 206 may permit the user to interact with device 200 to cause device 200 to perform one or more operations, such as place or receive a telephone call. In some implementations, control buttons 206 may include a telephone keypad (not shown) that may be complementary to graphical user interface (GUI) objects generated on touchscreen display 204. Microphone 210 may receive audible information from the user. Sensors 212 may include components that collect and provide information that is used to determine a motion and orientation of device 200 (e.g., accelerometers, gyroscopes, magnetometer, inertia-switch sensor, etc.). Sensors 212 may also collect and provide, to device 200, information (e.g., acoustic, infrared, etc.) that is used to aid the user in capturing images or in providing other types of information (e.g., a distance between a user and device 200). Front camera 214 may enable a user to view, capture and store images (e.g., pictures, video clips) of a subject in front of device 200. Housing 216 may provide a casing for components of device 200 and may protect the components from outside elements.

Headphone jack socket 218 may receive an input/output jack of a headset. Device 200 may output an audio signal to a headset connected via headphone jack socket 218.

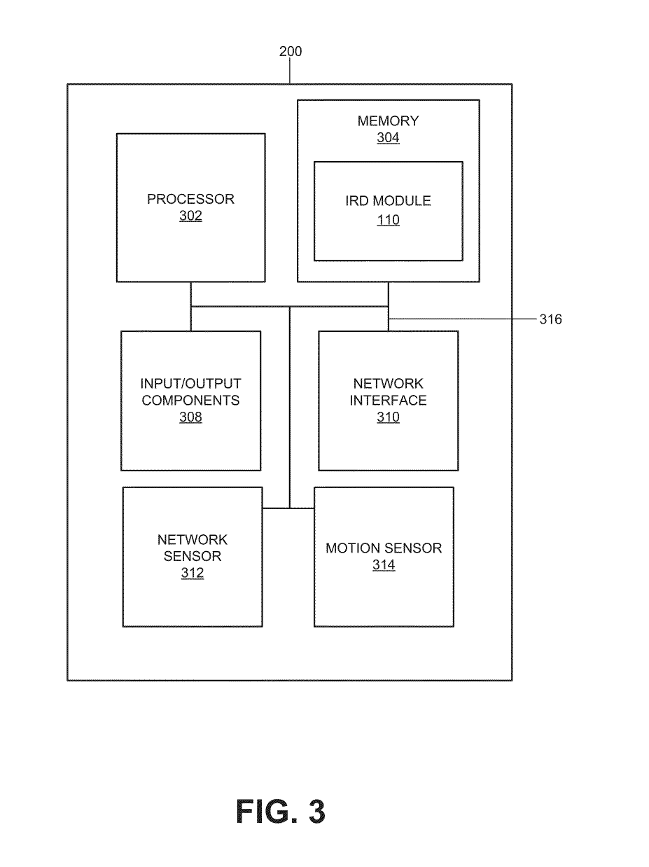

FIG. 3 is a block diagram of the device of FIG. 2. As shown in FIG. 3, device 200 may include a processor 302, a memory 304, input/output components 308, a network interface 310, a touch sensor 312 and a communication path 316. In different implementations, device 200 may include additional, fewer, or different components than the ones illustrated in FIG. 3. For example, device 200 may include additional network interfaces, such as interfaces for receiving and sending data packets.

Processor 302 may include a processor, a microprocessor, an Application Specific Integrated Circuit (ASIC), a Field Programmable Gate Array (FPGA), and/or other processing logic (e.g., audio/video processor) capable of processing information and/or controlling device 200.

Memory 304 may include static memory, such as read only memory (ROM), and/or dynamic memory, such as random access memory (RAM), or onboard cache, for storing data and machine-readable instructions. Memory 304 may also include storage devices, such as a floppy disk, CD ROM, CD read/write (R/W) disc, and/or flash memory, as well as other types of storage devices.

Memory 304 may include an intentional rotation detection application 306. Intentional rotation detection application 306 may include data and machine-readable instructions to detect intentional rotation of a mobile device. Intentional rotation detection application 306 may be executed by processor 302.

Input/output components 308 may include a display screen (e.g., touchscreen display 204, etc.), a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to device 200.

Network interface 310 may include a transceiver that enables device 200 to communicate with other devices and/or systems. For example, network interface 310 may include mechanisms for communicating via a network, such as the Internet, a terrestrial wireless network (e.g., a WLAN), a cellular network, a satellite-based network, a WPAN, etc. Additionally or alternatively, network interface 310 may include a modem, an Ethernet interface to a LAN, and/or an interface/connection for connecting device 200 to other devices (e.g., a Bluetooth interface).

Communication path 316 may provide an interface (e.g., a bus) through which components of device 200 may communicate with one another.

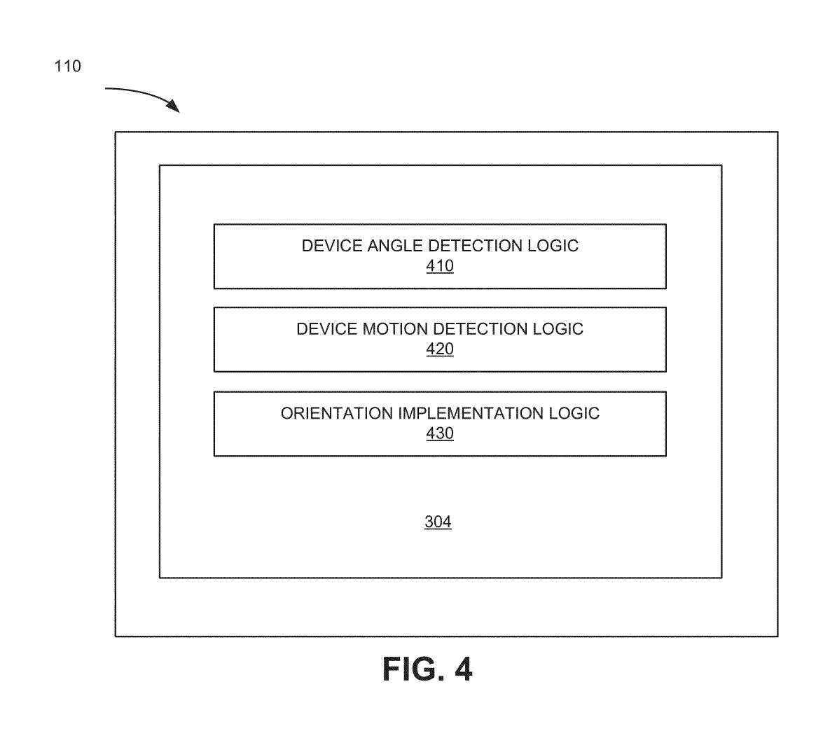

FIG. 4 is an exemplary functional block diagram of components implemented in IRD module 110. In an exemplary implementation, all or some of the components illustrated in

FIG. 4 may be stored in memory 304. For example, referring to FIG. 4, memory 304 may include device angle detection logic 410, device motion detection logic 420, and orientation implementation logic 430. In addition, various logic components illustrated in FIG. 4 may be implemented by processor 302 executing one or more programs stored in memory 304. Other configurations may be implemented. Therefore, IRD module 110 may include additional, fewer and/or different components than those depicted in FIG. 4.

Device angle detection logic 410 may detect angular positions of the mobile device 102. For example, device angle detection module 410 may detect a starting angular position (i.e., the angle of mobile device 102 prior to detected rotation), intermediate angular positions (e.g., IAP-1 or IAP-2 from FIGS. 1A and 1B respectively) of mobile device 102 during rotation, and an ending angular position (i.e., a resting position of mobile device 102 after the rotation). In some instances, the intermediate angular positions may be measured in all three planes of movement of the mobile device 102 (e.g., along all axes of the mobile device 102, including movement up and down of mobile device 102 in a vertical plane and movement towards and away from the user). Device angle detection logic 410 may also determine a change in angle of mobile device 102 from the starting angular position to the ending angular position.

Device angle detection logic 410 may detect when the device passes one or more predetermined rotation angle thresholds. The rotation angle thresholds of mobile device 102 may be a “tipping point” at which mobile device 102 transitions from a first orientation and/or configuration (e.g., a portrait orientation of the UI, a regular sized interface) to a second orientation or configuration (e.g., a landscape orientation of the UI, a zoomed interface, a backlit interface).

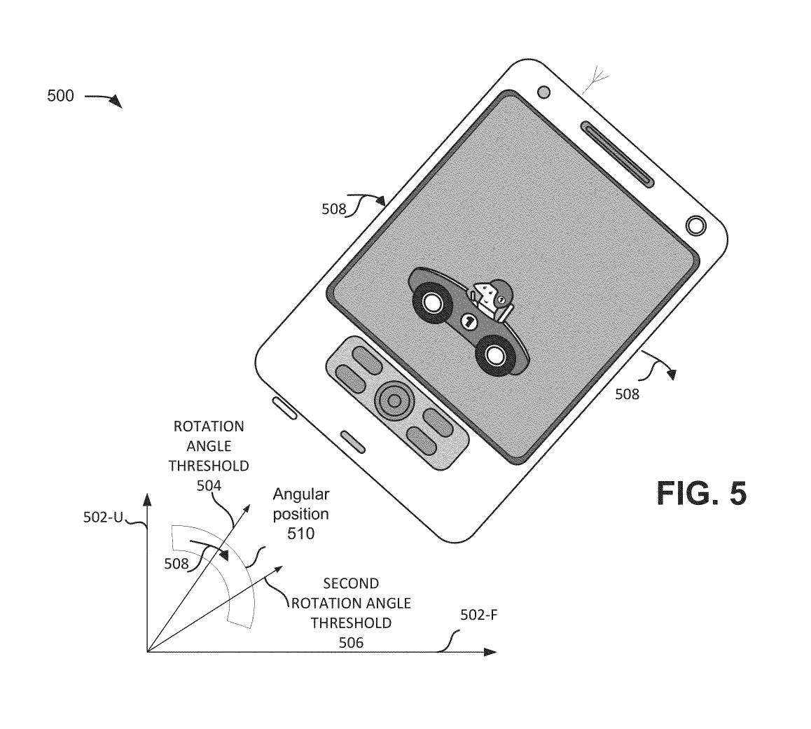

As shown in FIG. 5, device angle diagram 500 shows an angular position 510 of mobile device 510. Device angle detection logic 410 may detect angular position 510 of mobile device 102 at any point from the upright position 502-u to the flat position 502-f. Device angle detection logic 410 may detect that mobile device 102 has rotated past a rotation angle threshold 504. Device angle detection logic 410 may provide starting angular positions, ending angular positions and intermediate angular positions to device motion detection logic 420 based on whether the angular position of device 510 is as a result of a rotation 508. In some instances, device angle detection logic 410 may determine whether the angular position of mobile device 102 exceed a second rotation angle threshold 506, which is greater than the first rotation angle threshold 504.

Device motion detection logic 420 may determine a controlling angular position of mobile device 102. The controlling angular position may be an angular position of mobile device 102 that mobile device 102 determines that the user intends to control the orientation (and/or configuration) of mobile device 102. There is a 90 degree difference between the upright angular position and the flat angular position of mobile device 102. Mobile device 102 may be inclined at intermediate angular positions between the upright angular position and the flat angular position. When mobile device 102 rotates to an intermediate angular position that is beyond a rotation angle threshold, device motion detection logic 420 may determine a controlling angular position to control implementation of orientation on mobile device 102 based on whether the rotation was an intentional rotation 106 or an unintentional rotation 112.

Device motion detection logic 420 may detect a speed of rotation of the mobile device 102 during a rotation from the starting position to the ending position. For example, device motion detection module 420 may detect a beginning time at which the rotation begins, an ending time at which the rotation ends, a starting angular inclination, and an ending angular inclination of mobile device 102 with respect to a particular rotation. Device motion detection logic 420 may also determine whether the user is manipulating a position of mobile device consistent with intentional rotation 106 based on the changes in the intermediate angular positions in the other planes of motion of mobile device 102.

According to one implementation, device motion detection logic 420 may detect a fluidity of motion associated with the rotation. Device motion detection logic 420 may analyze a smoothness of an overall trajectory of mobile device 102 during the rotation. Device motion detection logic 420 may identify that when the user moves the mobile device 102 in more than a single motion the user is intentionally rotating mobile device 102. Consequently, a speed of rotation between intermediate angular positions and/or a trajectory of mobile device 102 between intermediate angular positions may vary for the multiple motions that are included in the intentional rotation 106 (e.g., the user may adjust a position of mobile device 102 using multiple small motions to “perfectly” position mobile device 102).

Device motion detection logic 420 may determine that the user is intentionally rotating mobile device 102 based on motion in planes of motion that are perpendicular to the plane of motion of the rotation. For example, the user may simultaneously (or at a near time) move the device closer when intentionally rotating mobile device 102. Device motion detection logic 420 may incorporate the analysis of the simultaneous movement in other planes into a determination whether the rotation is an intentional rotation 106 or an unintentional rotation 112. Additionally, intentional movement of mobile device 102 may be disjointed (as the user adjusts a position of mobile device 102) and/or preceded by secondary instructions provided to mobile device 102 (e.g., the user may turn up the volume before rotating mobile device 102).

According to another implementation, device motion detection logic 420 may determine whether the rotation is intentional based on a threshold size of the rotation angle. For example, device motion detection logic 420 may determine that the rotation is intentional for all instances in which the rotation exceeds a predetermined maximum (e.g., a rotation above 30 degrees may be presumed to be intentional).

According to another implementation, device motion detection logic 420 may determine mobile device 102 moves (or is moved) in a perpendicular plane to the plane of motion of the rotation (e.g., up, down, towards or away from the user) in a predetermined time span of the time of the rotation. For example, device angle detection logic 410 may determine whether mobile device 102 is moved in the perpendicular plane to the plane of motion of the rotation concurrently with the rotation and identify the rotation as an intentional rotation 106 if the motion in the perpendicular plane exceed a predetermined threshold (e.g., the user may bring mobile device 102 towards themselves while rotating mobile device 102, indicating an intentional rotation 106).

Orientation implementation logic 430 may implement different orientations (of the UI) and/or configurations (of features on mobile device 102, such as a sharpness setting, backlight setting, etc.) based on the controlling angular position of mobile device 102. In some instances, orientation implementation logic 430 may determine that the rotation beyond the second rotation angle threshold 506 is an intentional rotation 106, regardless of the speed of rotation. Orientation implementation logic 430 may be configured to transition mobile device 102 from the first orientation to the second orientation based on intentional rotation 106 of mobile device 102 from one controlling angular position (e.g., upright angular position) to the other controlling angular position (e.g., flat angular position).

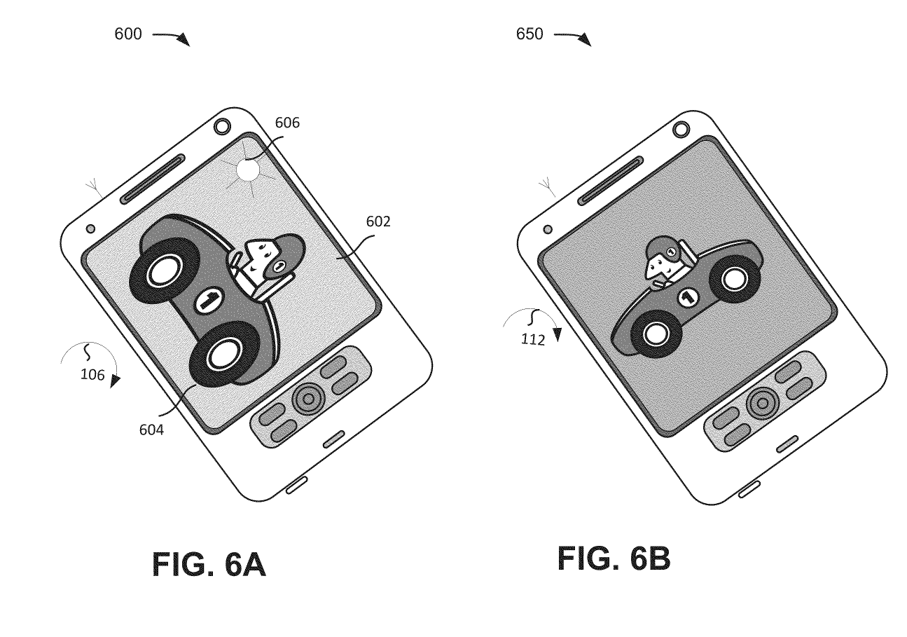

According to one implementation, as shown in FIGS. 6A and 6B are different orientations and configurations which orientation implementation logic 430 may implement based on the controlling angular position.

As shown in first orientation diagram 600 in FIG. 6A, in response to a determination that the rotation of mobile device 102 is an intentional rotation 106, orientation implementation module 430 may initiate a transition from a first state to a second state of mobile device 102. In one example, orientation implementation module 430 may initiate a transition to a particular orientation 602 (in this instance a landscape orientation) of the UI and/or function of mobile device 102 from a previous orientation and configuration (such as shown in FIG. 5). For example, orientation implementation module 430 may enlarge (604, shown as a larger image) a portion of the user interface. In another example, orientation implementation module 430 may provide a backlight 606 for the UI of mobile device 102. For example, orientation implementation module 430 may change the configuration of mobile device 102 from a regular backlighting configuration to an amplified backlighting configuration in response to a determination that the rotation is an intentional rotation 106.

As shown in FIG. 6B, in response to a determination that the rotation of mobile device 102 is an intentional rotation 106, orientation implementation module 430 may maintain mobile device 102 with a same orientation and configuration. Although mobile device 102 is at a same angular position in FIGS. 6A and 6B, different orientations and configurations are implemented on mobile device 102 in the two different instances because in the first instance (FIG. 6A) the angular position of mobile device 102 was determined to be as a result of an intentional rotation 106 while in the second instance (FIG. 6B) the angular position is determined to be as a result of an unintentional rotation 112.

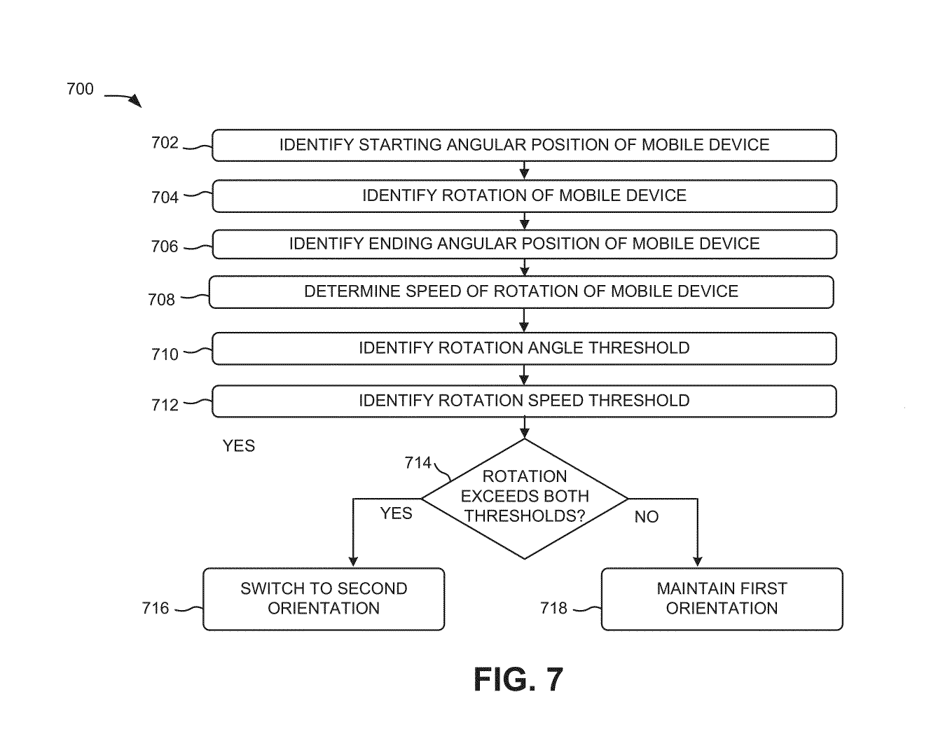

FIG. 7 is a flowchart of an exemplary process 700 for determining whether a detected rotation of a mobile device 102 is an intentional rotation 106 or an unintentional rotation 112 in a manner consistent with implementations described herein. Process 700 may execute in mobile device 102. It should be apparent that the process discussed below with respect to FIG. 7 represents a generalized illustration and that other elements may be added or existing elements may be removed, modified or rearranged without departing from the scope of process 700.

Mobile device 102 may identify a starting angular position of mobile device 102 (block 702). For example, mobile device 102 may determine that mobile device 102 remains stationary in the starting angular position for longer than a predetermined minimum stationary interval (e.g., a 3 second interval). In one example, mobile device may identify that mobile device 102 is at an 80 degree angular position (i.e., ten degrees from upright) and in a portrait orientation.

Mobile device 102 may identify rotation of mobile device 102 (block 704). For example, mobile device 102 may determine that the angular position of mobile device 102 has changed from the starting angular position.

At block 706, mobile device 102 may identify an ending angular position of mobile device 102 after the rotation. For example, mobile device 102 may identify that the ending angular position is at a 40 degree angular position.

Mobile device 102 may determine a speed of rotation of mobile device 102 (block 708). For example, mobile device 102 may determine a time from a start of the rotation to the end of the rotation and a change in rotation angle. Mobile device 102 may determine the speed of rotation based on the change in rotation angle and the time of rotation.

At block 710, mobile device 102 may identify a rotation angle threshold. The rotation angle threshold may be a rotation angle above which mobile device 102 indicates that the rotation is to be analyzed to determine whether the rotation is an intentional rotation 106 or an unintentional rotation 112.

Mobile device 102 may identify a rotation speed threshold for intentional rotation (block 712). The rotation speed threshold may be a speed above which the rotation of the mobile device 102 will be presumed to be an intentional rotation.

According to one embodiment, mobile device 102 may identify other attributes of the rotation, such as a distance travelled along other axes (e.g., if the user lifts the mobile device 102 or brings the mobile device 102 towards their body).

Device 102 may determine whether the rotation exceeds both the rotation angle threshold and the rotation speed threshold (block 714).

At block 716, in response to a determination (block 714—yes) that the rotation exceeds both the rotation angle threshold and the rotation speed threshold, mobile device 102 may implement a transition from a first orientation of mobile device 102 (associated with a particular controlling angular position, e.g., an upright angular position) to a second orientation (associated with a different controlling angular position, e.g., a flat angular position). Mobile device 102 may identify the rotation as an intentional rotation 106 based on additional or alternative factors associated with the motion of mobile device 102 during the rotation. For example, mobile device 102 may determine a change in the rotation angle from the starting angular position to the ending angular position. If the change in the rotation angle exceeds a predetermined threshold, mobile device 102 may identify the rotation as an intentional rotation.

At block 718, in response to a determination (block 714—yes) that the rotation does not exceed one or both of the rotation angle threshold and the rotation speed threshold, mobile device 102 may maintain a current orientation and/or configuration of mobile device 102.

Systems and methods described herein may use multiple accelerometer measure points to detect a rotation speed associated with a device rotation. The systems may distinguish between intentional rotations and unintentional rotations using rotation speed and rotation angle.

The foregoing description of implementations provides illustration, but is not intended to be exhaustive or to limit the implementations to the precise form disclosed. Modifications and variations are possible in light of the above teachings or may be acquired from practice of the teachings.

In the above, while series of blocks have been described with regard to the exemplary processes, the order of the blocks may be modified in other implementations. In addition, non-dependent blocks may represent acts that can be performed in parallel to other blocks. Further, depending on the implementation of functional components, some of the blocks may be omitted from one or more processes.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A computer-implemented method for detecting intentional rotation of a mobile device, the method comprising:
identifying a starting angular position of the mobile device, wherein the mobile device includes a user interface in a first orientation and a first configuration;
identifying a rotation of the mobile device;
identifying an ending angular position of the mobile device after the rotation;
determining a speed of rotation of the mobile device;
identifying a rotation angle threshold;
identifying a rotation speed threshold;
determining whether the rotation exceeds the rotation angle threshold and the rotation speed threshold; and
identifying the rotation as an intentional rotation in response to a determination that the rotation exceeds the rotation angle threshold and the rotation speed threshold.

2. The computer-implemented method of claim 1, further comprising:
switching the user interface to a second orientation in response to a identifying that the rotation as an intentional rotation.

3. The computer-implemented method of claim 1, further comprising:
switching the user interface to a second configuration in response to identifying that the rotation as an intentional rotation.

4. The computer-implemented method of claim 3, wherein the first configuration is a regular backlighting configuration and the second configuration is an amplified backlighting configuration.

5. The computer-implemented method of claim 1, further comprising:
maintaining the user interface in the first orientation in response to a determination that the rotation does not exceed the rotation speed threshold.

6. The computer-implemented method of claim 1, further comprising:
determining whether the rotation is the intentional rotation based on a fluidity of the rotation.

7. The computer-implemented method of claim 1, further comprising:
determining whether the rotation exceeds a second rotation angle threshold in response to a determination that the rotation exceeds the rotation angle threshold and does not exceed the rotation speed threshold; and
switching the user interface to the second orientation in response to a determination that the rotation exceeds the second rotation angle threshold.

8. The computer-implemented method of claim 1, further comprising:
determining whether the mobile device is moved in a perpendicular plane of motion in a predetermined time span of the time of the rotation; and
switching the user interface to the second orientation in response to a determination that the mobile device is moved in a perpendicular plane of motion in a predetermined time span of the time of the rotation.

9. The computer-implemented method of claim 1, wherein determining the further comprises:
determining whether a secondary input is received at the mobile device in a predetermined time prior to the rotation; and
switching the user interface to the second orientation in response to a determination that the secondary input is received at the mobile device in a predetermined time prior to the rotation.

10. The computer-implemented method of claim 1, wherein determining the speed of rotation of the mobile device further comprises determining the speed of rotation of the mobile device based on the rotation angle and the time of rotation of the mobile device.

11. The computer-implemented method of claim 1, further comprising:
determining whether a change in the rotation angle exceeds a predetermined threshold; and
identifying the rotation as the intentional rotation in response to a determination that the change in the rotation angle exceeds a predetermined threshold.

12. A mobile device, comprising:
a user interface configurable to be displayed in a first orientation or a second orientation;
a memory to store a plurality of instructions; and
a processor configured to execute instructions in the memory to:
identify a starting angular position of the mobile device, wherein the user interface in the first orientation and a first configuration;
identify a rotation of the mobile device;
identify an ending angular position of the mobile device after the rotation;
determine a speed of rotation of the mobile device;
identifying a rotation angle threshold;
identify a rotation speed threshold;
determine whether the rotation exceeds the rotation angle threshold and the rotation speed threshold; and
identify the rotation as an intentional rotation in response to a determination that the rotation exceeds the rotation angle threshold and the rotation speed threshold.

13. The mobile device of claim 12, wherein the processor is further configured to:
switch the user interface to a second orientation in response to a identifying that the rotation as an intentional rotation.

14. The mobile device of claim 12, wherein the processor is further configured to:
switch the user interface to a second configuration in response to a identifying that the rotation as an intentional rotation.

15. The mobile device of claim 13, wherein the second configuration includes at least one of an enlarged image, or a backlit interface.

16. The mobile device of claim 12, wherein the processor is further configured to:
lock the user interface in the first orientation in response to a determination that the rotation does not exceed the rotation speed threshold.

17. The mobile device of claim 12, wherein the processor is further configured to:
determine whether the rotation exceeds a second rotation angle threshold in response to a determination that the rotation exceeds the rotation angle threshold and does not exceed the rotation speed threshold; and
switch the user interface to the second orientation in response to a determination that the rotation exceeds the second rotation angle threshold.

18. The mobile device of claim 12, wherein the processor is further configured to:
determine whether a secondary input is received at the mobile device in a predetermined time prior to the rotation; and
switch the user interface to the second orientation in response to a determination that the secondary input is received at the mobile device in a predetermined time prior to the rotation.

19. The mobile device of claim 12, wherein the processor is further configured to:
determine whether a change in the rotation angle exceeds a predetermined threshold; and
identify the rotation as the intentional rotation in response to a determination that the change in the rotation angle exceeds a predetermined threshold.

20. A computer-readable medium including instructions to be executed by a processor, the instructions including one or more instructions, when executed by the processor, for causing the processor to:
identify a starting angular position of the mobile device, wherein the user interface in a first orientation and a first configuration;
identify a rotation of the mobile device;
identify an ending angular position of the mobile device after the rotation;
determine a speed of rotation of the mobile device;
identify a rotation angle threshold and a rotation speed threshold;
determine whether the rotation exceeds the rotation angle threshold and the rotation speed threshold;
identify the rotation as an intentional rotation in response to a determination that the rotation exceeds the rotation angle threshold and the rotation speed threshold; and
switch the user interface to a second orientation in response to a identifying that the rotation as an intentional rotation.
